(19) United States
(12) Patent Application Publication
(10) Pub. No.: US 2008/0270510 A1
(43) Pub. Date: Oct. 30, 2008

(54) Process to allow an internet website to display dynamic, real-time, customized content to the visitor

(76) Inventor: Larry D Kolinek, Austin, TX (US)

Correspondence Address: LARRY D. KOLINEK, 2808 CASCADE FALLS DR., AUSTIN, TX, 78738, US

(21) Appl. No.: 11/740,929

(22) Filed: Apr. 27, 2007

Related U.S. Application Data
(60) Provisional application No. 60/745,753, filed on Apr. 27, 2006.

(51) Int. Cl. G06F 15/16

(52) U.S. Cl. 709/200

(57) ABSTRACT

The process allows website owners to dynamically display custom, real time information to their website visitors. This “Displayed Information” is based on Visitor IP address, Visitor URL address, and Visitor search terms (or the lack of Visitor IP address, URL address or search terms), combined with information stored in the website owner's database. This “Displayed Information” will address the needs or desires of the Visitor as determined by this process.

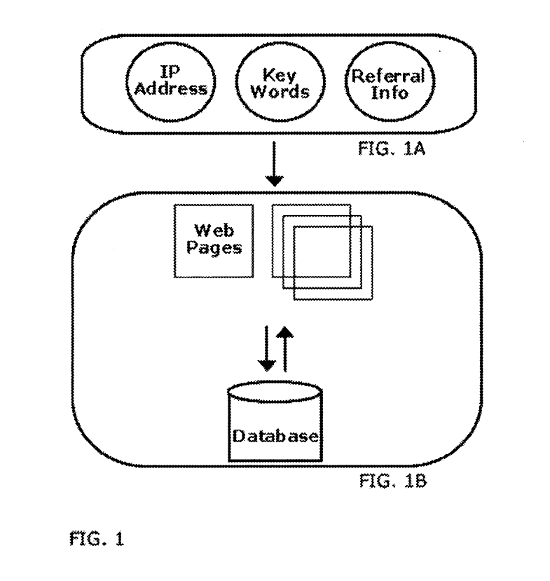

### BACKGROUND OF INVENTION

### Definitions

1) Internet. The publicly accessible computer network that connects many smaller networks from around the world. The system grew out of a US Defense Department initiative called Advanced Research Projects Agency Network (ARPANET) developed in the 1960's to ensure secure communications network. It quickly became popular with researchers and academics who immediately benefited from a capacity to communicate instantly by e-mail.

2) Web browser. A software program, often simply called a browser, that enables computers to locate and display web pages. The two most popular browsers are Netscape Navigator and Microsoft's Internet Explorer. Like most modern browsers these programs are used to display multi-media information including graphics, video and audio.

3) Cyberspace. An increasingly common term used to describe a non-physical electronic environment where visitors can communicate via e-mail and access information like files, music and graphics from a computer, without having to travel physically.

4) Online. In the context of this submission the term means a computer connected to the Internet via a modem.

5) E-commerce or electronic commerce is business that is carried out over the Internet

6) Universal Resource Locator. Usually abbreviated to URL, this is the universally adopted global address of pages on the World Wide Web. Every page, or document on the WWW has a discreet URL, which also contains instructions and formatting protocols needed by web browsers to display information.

7) http. Hyper Text Transfer Protocol defines the communications codes used by WWW to define how messages are formatted and transmitted and how Web servers and browsers are to respond to commands. Importantly this protocol is known as a “stateless protocol” because each command is executed independently, without any knowledge of previous instructions. This makes it difficult to create web-sites that tailor information to the users needs.

8) Domain Name. These are discreet names that are incorporated into the URL of each Web page and are associated with one or more IP addresses.

9) Internet Service Providers or ISP, are companies that provide consumers with access to the Internet.

10) IP address. A 32-bit numeric address that is associated with an individual URL.

11) Referral Information. Data provided by a website visitor.

### Section 1. History

1.1 The World Wide Web (WWW) or (Web) is primarily a set of protocols and facilitating hardware that employs the telephone wires, radio signals, dedicated cables, satellites and communications networks of the Internet (1) to enable computers with suitable web-browsers (2) to exchange information.

1.2 An Englishman named Tim Berners-Lee, while working at CERN—a High Energy Physics research facility—in Switzerland, configured the system that was to become the WWW in response to the problem of computers with different software and communication protocols needing to exchange information.

1.3 People at this international research facility of CERN used various computer types and software programs to analyze data from particle accelerators that smashed matter into sub-atomic sizes. Accessing and exchanging information on these totally different computing systems was a problem that often necessitated the writing of complex programs solely for this task.

1.4 Burners-Lee had to repeatedly write purpose-written programs to enable communication between these different computer systems and that motivated him to propose a permanent fix that was the genesis of the World Wide Web.

1.5 His innovation, when coupled with an existing embryo international communications network called the Internet, allowed computers from around the world to “hook up” in a matrix that resembled a web and meet in an abstract imaginary point somewhere in cyberspace (3), to exchange information.

1.6 It didn't take long for commercial organizations to see the benefits of promoting products “online”, as it had became known. The protocols for communications and the display of information, whether graphic or text, that are at the heart of the WWW were standardized by ad hoc working groups, without the constraints or politics of government agencies, and then universally adopted internationally by all participants in this virtual community.

1.7 That standards were agreed to outside of any single national government's control or any commercial entity is very important because it led to a universal acceptance of the formats and communications protocols that were needed for the success of online, (4) or e-commerce (5).

1.8 One of the most important of these protocols is the Universal Resource Locator (6) or URL. Every page that is downloaded over the Internet, using the established procedures of the WWW, has an individual URL, which usually starts with “http” (7), the first formatting protocol adopted by Berners-Lee. The now familiar identifier of “www” follows, after which comes the domain name (8) and other information used to identify the page.

1.9 This specifically formatted information allows WWW server computers, the first link in this web matrix, to provide a specific IP address representing the URL, in the form of a coded number, to interrogating computers seeking to view the page via their web browser programs and Internet Service Providers (ISP) (9).

1.10 Importantly, the interrogating computer is also allocated an IP address that, like a telephone number, discloses information to the host computer about the party seeking to have the specific page downloaded

1.11 The web page IP address is given to the interrogating computer seeking to view the specific page identified by the coded number representing the URL and then sent out to the WEB, where all the interconnected computers use it as a routing and identifier code in much the same way as a mail sorting system uses zip codes. Each Internet computer in the network receiving the request looks for the shortest electronic pathway to send the inquiry to the host computer (10) of that URL page.

1.12 These internationally standardized URL's, the concomitant IP addresses and communication protocols are standardized and universally adopted by all who use the Web. They are at the heart of the World Wide Web, and their general acceptance is the reason for the global success and phenomenal growth of e-commerce and online marketing.

### Section 2. Online Marketing

2.1 Statistics for goods and services marketed and sold using the Web, in the broad generic category of “business to consumer”, are difficult to quantify because of the somewhat unregulated nature of this new marketing method and its relative immaturity as an industry.

2.2 What can be said is that after the initial security concerns by consumers were addressed and regulators legislated against fraudulent practices, e-commerce and online marketing has become the fastest growing means of providing goods and services to consumers.

2.3 User-friendly “shopping cart” programs, secure payment methods, increasing consumer confidence and the lower overheads of virtual outlets have inspired predictions of an explosive growth for business to consumer sales online.

2.4 Information about every type of service and product can now be accessed online. Almost any commodity can purchased using the WWW, from low-cost consumables to major capital purchases such as homes and vehicles. Commitments for almost any service, from a plumber to a root canal can be made over the Internet.

2.5 Business to business sales are also increasing with more and more companies building sites that allow clients to make service and product choices online.

2.6 To be successful, a virtual store requires the exact same steady stream of visitors who “convert” into purchasers that a profitable “bricks and mortar” store does. However, because online marketing is such a recent innovation, methods to both drive potential purchasers to the virtual store, and techniques to convert these visitors into customers, are still evolving.

### Section 3. The Inventive Step Used to Create ACROI

3.1 Put simply the invention is a process that uses information embedded in a visitors request to a web-site host computer, in interrelated ways that have not previously been employed, to create a real-time, dynamic, database driven personalized response page that directly addresses the query and the unique circumstances of any visitor.

3.2 ACROI achieves this using firstly the visitors IP address that is available to a host computer, in the same way that a caller's telephone number is available to the phone receiving an incoming call.

3.3 Virtual stores or organizations using the WWW to sell, promote and brand products can use the IP address of site visitors to establish statistical details about potential customers. The zip code, the region, the city and originating country of the site visitor can be ascertained from the IP address, as well as the party's ISP and the domain name if applicable.

3.4 The host computer, using the ACROI program, can further use this information by cross referencing it against stored data about prior site visitors to establish if a request is from a party who has visited previously to make purchases or requests for information or if this is a first time visit.

3.5 ACROI also uses the IP address to establish, with a high degree of probability, if this visitor is a private individual, a competitor or a commercial organization.

3.6 Another detail embedded in requests to website hosting computers is the URL of any referral page link. The absence of a link site referral is also an important detail that tells the system a lot about the visitor. In either case the ACROI database manager uses the information to further personalize the request response page.

3.7 Also available to website host computers is the search engine term or phrase used by site visitors, if that is the method of referral to find the page and this information is also used by the ACROI program to further dynamically personalize the page.

3.8 The inventive step employed by ACROI, is to take all this derived data originating from the three discreet sources of firstly the IP address, the referral URL and the search engine terms used (or the absence of one or both of a link URL and/or search engine term) by the interrogating inquiry, to create in real time, from a database, a dynamic, personalized page that speaks directly to the site visitor's needs.

1. A process comprising of any dynamic, interdependent use of the multiple, discreet items of data available to website owners, under the headings of IP Address, URL Referral and the Search Engine Keyword Terms used by the visitor, and the derivative information that can be gleaned from them, or their absence, to create personalized web page content, in real time, would be a breach of this process.
